(19) United States
(12) Patent Application Publication
(10) Pub. No.: US 2007/0134992 A1
(43) Pub. Date: Jun. 14, 2007

(54) Connection system that couples a contact of a flat block of components to an apparatus

(76) Inventors: Siegfried Hofler, Neunkirchen (DE); Stefan Nowak, Hessdorf (DE); Wieland Portisch, Erlangen (DE)

Correspondence Address: BRINKS HOFER GILSON & LIONE, P.O. BOX 10395, CHICAGO, IL, 60610, US

(21) Appl. No.: 10/588,241

(22) PCT Filed: Dec. 29, 2004
(86) PCT No.: PCT/EP04/53725

§ 371 Date: Aug. 1, 2006

(30) Foreign Application Priority Data
Feb. 4, 2004 (DE) 10 2004 005 545.9

(51) Int. Cl. H01R 9/22

(52) U.S. Cl. 439/709

(57) ABSTRACT

A connection system that couples a contact of a flat block of components to an apparatus is provided. The connection system comprises a conductive connecting element electrically coupled to the contact of the flat block of components, and a clamping device electrically coupled to the apparatus. The clamping device receives the connecting element. The connecting element is a rigid conductor. The rigid conductor is a screw fastened conductively to the contact. The screw penetrates a bore in the flat block of components and is locked by a nut on a second side of the flat block of components, which is opposite a first side of the flat block of components.

The present patent document is a continuation of PCT Application Serial Number PCT/EP2004/053725, filed Dec. 29, 2004, designating the United States, which is hereby incorporated by reference and which claims priority to German Application No. 10 2004 005 545.9, filed Feb. 4, 2004.

### BACKGROUND

1. Field

The present embodiments relate to a connection system for connecting a contact of a flat block of components to an apparatus.

2. Related Art

Conventionally, a connection system has a cable harness. A conductive connecting element includes individual conductors of the cable harness, which are insulated from one another. The cable harness can be a disadvantage because there are multiple individual conductors that need to be connected, which increases the possibility that there will be incorrect electrical connections or short circuits. Thus, there is a need for a simplified connection system.

### SUMMARY

The present embodiments are directed to a connection system that couples a contact of a flat block of components to an apparatus, which may obviate one or more of the problems due to the limitations and disadvantages of the related art.

In a preferred embodiment, the connection system that couples a contact of a flat block of components to an apparatus comprises a conductive connecting element. The connecting element is electrically coupled to the contact of the flat block of components. A clamping device is electrically coupled to the apparatus. The clamping device receives the connecting element. Accordingly, the connecting element electrically couples the apparatus and the contact of the flat block of components.

In a preferred embodiment, the connecting element is a rigid conductor, and the connecting element directly engages the clamping device of the apparatus. Accordingly, the connecting element is directly coupled to the clamping device. Because the connecting element is a rigid conductor that is coupled to the flat block of components, confusing the conductor with another conductor is prevented, and thus incorrect wiring is also prevented. In addition, plugs and fasteners for the flat block of components are no longer needed. Because the connecting element engages the clamping device of the apparatus directly, a compact construction of the connection system is furthermore attained.

In a first embodiment, the flat block of components is a printed circuit board. The rigid conductor is an extension or tongue of the printed circuit board material. The contact is a conductor track disposed on the extension of the printed circuit board material. In this embodiment, no additional components are needed to furnish the connecting element.

In a second embodiment, the rigid conductor is a metal bolt, which is electrically fastened directly to the contact of the flat block of components. Alternatively, the rigid conductor is a screw electrically fastened directly to the contact of the flat block of components. In this embodiment, the screw has a head and a shaft comprising a thread. The shaft is disposed in a bore in the flat block of components in the region of the contact. The screw is locked via a nut on a second side of the flat block of components, which is opposite a first side of the flat block of components.

In a third embodiment, the head of the screw is electrically coupled with the contact on the first side of the flat block of components. The nut of the screw is electrically coupled with the contact on the second side of the flat block of components. Accordingly, the contact and the connecting element are electrically coupled.

In another embodiment, the head and the nut of the screw are soldered or welded to the contact. Alternatively, the head or the nut of the screw is soldered or welded to the contact.

In a preferred embodiment, the flat block of components is an assembled printed circuit board. For example, the inverter is at least one rectifier. The inverter is connected to the apparatus via the connecting element and the clamping device.

In another exemplary embodiment, the clamping device is directly coupled to the apparatus. Alternatively, the clamping device of the apparatus is coupled to the apparatus via a securing robot that is electrically coupled to the apparatus. If a plurality of securing robots are used in a preferred embodiment, it is advantageous to have the securing robots disposed in a row on a distributor busbar.

When the connection system couples a plurality of contacts of the flat block of components to a plurality of clamping devices of the apparatus, the plurality of the connecting elements are disposed in accordance with the disposition of the clamping devices on the flat block of components.

In the preferred embodiments, the connection system is suitable for the apparatus. For example, the connection system is suitable for an apparatus, which is a transformer for a potential-free supply voltage for full bridge inverters of a magnetic resonance gradient amplifier.

In another embodiment, the clamping device is a screw terminal or a spring clip. For example, the connection between the at least one connecting element and the at least one clamping device can be disconnected.

In a preferred embodiment, the connection system is suited to conduct voltages of over 24 volts. In another preferred embodiment, the connection system is suited to conduct voltages over 120 volts, and even more preferably over 240 volts. In a preferred embodiment, the connection system is suited to conduct currents over 0.5 amperes. In another preferred embodiment, the connection system is suited to conduct currents over 1 ampere, and even more preferably over 10 amperes.

In the ensuing detailed description, the preferred embodiments will be described in terms of one exemplary embodiment in conjunction with the accompanying drawings. In the drawings, the same reference numerals identify the same elements.

### BRIEF DESCRIPTION OF THE DRAWINGS

Further advantages, characteristics and details will become apparent from the ensuing exemplary embodiments and from the drawings. In the drawings:

FIG. 1 schematically shows one exemplary embodiment of the connection system; and

FIG. 1′ shows a top view of a rigid connector of the connection system of FIG. 1.

### DETAILED DESCRIPTION OF THE PREFERRED EMBODIMENTS

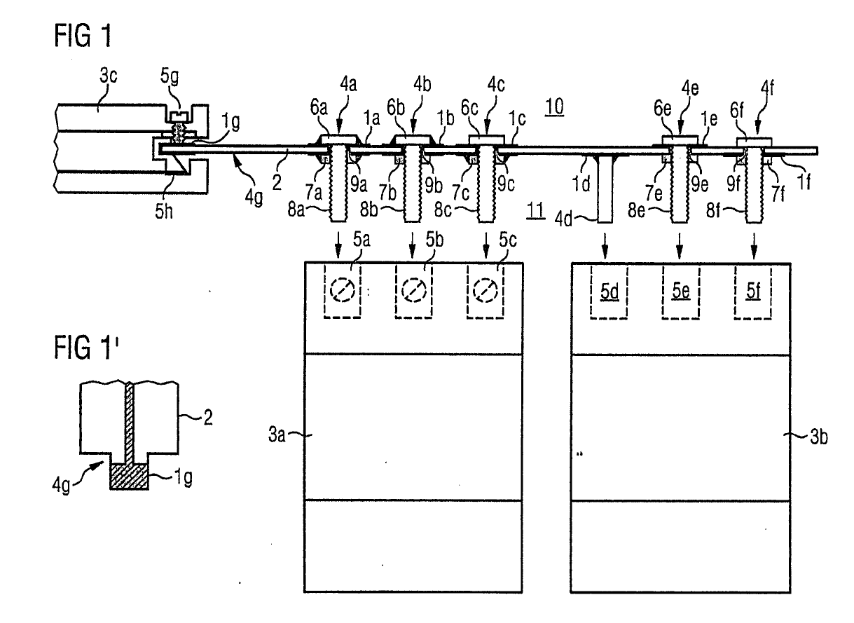

In FIGS. 1 and 1′, the connection system of the invention is explained, for example, in the context of use with magnetic resonance gradient amplifiers.

The connection system serves to connect contacts 1a, 1b, 1c, 1d, 1e, 1f, and 1g of rectifiers (the rectifiers are not shown in FIG. 1) disposed on a printed circuit board 2 to transformers 3a, 3b, and 3c, which furnish a potential-free supply voltage for full bridge inverters, connected to the rectifiers, of a magnetic resonance gradient amplifier. The rectifiers together with the printed circuit board 2 form a flat block of components.

The inputs of the rectifiers are coupled to conductor tracks (not shown) disposed on the printed circuit board 2. The contacts 1a, 1b, 1c, 1d, 1e, 1f, and 1g of the inputs of the rectifiers are disposed on the printed circuit board 2 in accordance with the disposition of clamping devices 5a, 5b, 5c, 5d, 5e, 5f, and 5g of the transformers 3a, 3b, and 3c.

In FIG. 1, the transformer 3a has three clamping devices 5a, 5b, and 5c, each with a screw terminal. The transformer 3b has three clamping devices 5d, 5e, and 5f, each with a spring clip. The transformer 3c is coupled to both a screw terminal 5g and a spring clip 5h.

As shown in FIG. 1′, in a first embodiment, a portion of the printed circuit board material, which forms the printed circuit board 2, has a contact 1g. The contact 1g is a rigid conductor. The contact 1g is a connecting element 4g that connects to the transformer 3c, via the screw terminal 5g and the spring clip 5h. As shown in FIG. 1, the transformer 3c is embodied, by means of the clamping devices 5g and 5h, to receive at least one part of the tongue 4g, carrying the contact 1g, in order to furnish a direct electrical contact with the rectifiers disposed on the printed circuit boards 2. In this embodiment, the clamping devices 5g and/or 5h are connected to the electronic components of the transformer 5c and the rectifiers disposed on the printed circuit boards 2.

In another embodiment, screws 4a, 4b, and 4c are secured directly to the corresponding contacts 1a, 1b, and 1c of the printed circuit board 2. The screws 4a, 4b, and 4c each have a head 6a, 6b, and 6c, respectively, and a shaft 8a, 8b, and 8c. The shaft 8a, 8b, and 8c penetrates the bores 9a, 9b, and 9c, which are made in the printed circuit board 2 in the region of the contacts 1a, 1b and 1c. The shafts 8a, 8b, and 8c are electrically coupled to the bores 9a, 9b, and 9c. On a second side 11 of the printed circuit board 2, which is diametrically opposite the heads 6a, 6b, and 6c of the screws 4a, 4b, and 4c, the screws 4a, 4b, and 4c, are locked by nuts 7a, 7b, and 7c. As can be seen in FIG. 1, the contacts 1a, 1b, and 1c are disposed through the bore 9a, 9b, and 9c from a first side 10 oriented toward the heads 6a, 6b, and 6c of the screws 4a, 4b, and 4c to the second side 11. Accordingly, the head 6a, 6b, and 6c and the nuts 7a, 7b, and 7c and the shaft 8a, 8b, and 8c of the screws 4a, 4b, and 4c are electrically coupled to the contacts 1a, 1b, and 1c of the printed circuit board 2.

In a preferred embodiment, the head 6b and the nut 7c of the screws 4b and 4c, respectively, are soldered to the contacts 1b and 1c of the printed circuit board 2. In another preferred embodiment, both the head 6a and the nut 7a are soldered to the respective contact 1a. Accordingly, the screws 4a, 4b, and 4c are electrically connected or coupled to the contacts 1a, 1b, and 1c of the printed circuit board 2 by rigid connecting elements.

The screw terminals 5a, 5b, and 5c of the associated transformer 3a receive the screws 4a, 4b, and 4c. The screws 4a, 4b, and 4c electrically couple the transformer 3a and the respective contact 1a, 1b, and 1c of the printed circuit board 2. The screws 4a, 4b, and 4c directly engage the screw terminals 5a, 5b, and 5c of the transformer 3a. Accordingly, the transformer 3a is directly and immediately coupled to the screw terminals 5a, 5b, and 5c.

In an alternate embodiment, the transformer 3b has spring clips 5d, 5e, and 5f instead of screw terminals. The contacts 1d, 1e, and 1f of the rectifiers associated with the transformer 3b are disposed on only one side of the printed circuit board 2. The contact 1d is electrically coupled to the associated spring clip 5d of the transformer 3b. A metal bolt 4d is electrically secured by soldering the metal bolt 4d directly to the contact 1d of the printed circuit board 2. The associated spring clip 5d receives and electrically contacts the metal bolt 4d.

The screws 4e and 4f differ from the screws 4b and 4c only in that they are not soldered to the associated contacts 1e and 1f, respectively.

In another embodiment, the spring clips 5e and 5f are electrically coupled to the associated screws 4e and 4f, which directly engage the spring clips 5e and 5f. The transformer 3b is electrically coupled to the contacts 1e and 1f.

In the connection system of the preferred embodiments, an electrical connection is made via rigid conductors, such as metal bolts, screws, or printed circuit board extensions, and thus no separate mounts for the printed circuit board 2 are necessary. Mistakes in wiring can be avoided.

In an alternate embodiment, which is not shown, the elements 3a and 3b are securing robots, disposed in a row in a distributor busbar. An electrical connection is made between an arbitrary electrical apparatus, connected to the securing robots, and contacts of the printed circuit board 2.

While the invention has been described above by reference to various embodiments, it should be understood that many changes and modifications can be made without departing from the scope of the invention. It is therefore intended that the foregoing detailed description be regarded as illustrative rather than limiting and that it be understood that it is the following claims, including all equivalents, that are intended to define the spirit and scope of this invention.

1. A connection system for connecting a contact of a flat block of components to an apparatus, the connection system comprising:
a conductive connecting element electrically coupled to the contact of the flat block of components; and
a clamping device electrically coupled to the apparatus,
wherein the clamping device receives the connecting element,
wherein the connecting element is a rigid conductor, the rigid conductor being a screw fastened conductively to the contact, and
wherein the screw penetrates a bore in the flat block of components and is locked by a nut on a second side of the flat block of components, which is opposite a first side of the flat block of components.

2. The connection system as defined by claim 1,
wherein the flat block of components is a printed circuit board.

3. (canceled)

4. The connection system as defined by claim 2,
further comprising an inverter of a magnetic resonance gradient amplifier, the inverter comprising a rectifier, which is disposed on the printed circuit board and is coupled to the apparatus.

5. The connection system as defined by claim 1,
wherein the connection system connects a plurality of contacts of the flat block of components to a plurality of clamping devices, including the clamping device, of the apparatus,
and the connecting element is disposed on the flat block of components in accordance with the disposition of the clamping devices.

6. The connection system as defined by claim 1,
wherein the clamping device is a screw terminal or a spring clip.

7. The connection system as defined by claim 1,
wherein the connection system is suited to conduct voltages of over 24 volts, currents of over 0.5 ampere, or the combination thereof.

8. A flat block of components comprising:
a contact that is coupled to an apparatus, which is electrically coupled to a clamping device, and
a conductive connecting element electrically coupled to the contact,
wherein the conductive connecting element is a rigid conductor, the rigid conductor being a screw fastened electrically to the contact, and
wherein the screw penetrates a bore in the flat block of components and is locked by a nut on a second side of the flat block of components, which is opposite a first side of the flat block of components.

9-14. (canceled)

15. The connection system as defined by claim 1,
wherein the clamping device is disposed directly on the apparatus or coupled to the apparatus via a separate securing robot electrically coupled to the apparatus.

16. The connection system as defined by claim 8,
wherein a plurality of securing robots are disposed in a row on a distributor busbar.

17. The connection system as defined by claim 16,
wherein the apparatus is a transformer that furnishes a potential-free supply voltage for full bridge inverters of a magnetic resonance gradient amplifier.

18. The connection system as defined by claim 1, wherein the connecting element directly engages the clamping device of the apparatus.

19. The connection system as defined by claim 1, wherein the screw has a head which is electrically coupled with the contact on the first side of the flat block of components.

20. The connection system as defined by claim 1, wherein the nut is electrically coupled with the contact on the second side of the flat block of components.

21. The connection system as defined by claim 19, wherein the head of the screw is soldered or welded to the contact.

22. The connection system as defined by 1, wherein the nut is soldered or welded to the contact.

23. The flat block of components as defined by claim 8, wherein the connecting element is directly coupled to the clamping device of the apparatus.

24. The flat block of components as defined by claim 8, wherein the flat block of components is a printed circuit board.

25. The flat block of components as defined by claim 24, further comprising an inverter of a magnetic resonance gradient amplifier, the inverter comprising a rectifier which is disposed on the printed circuit board and is connected to the apparatus.

26. The flat block of components as defined by claim 8, wherein the screw has a head that is electrically coupled with the contact on the first side of the flat block of components.

27. The flat block of components as defined by claim 8, wherein the nut is electrically coupled with the contact on the second side of the flat block of components.

28. The flat block of components as defined by claim 26, wherein the head of the screw is soldered or welded to the contact.

29. The flat block of components as defined claim 27, wherein the nut is soldered or welded to the contact.
